(19) United States
(12) Patent Application Publication
(10) Pub. No.: US 2005/0232241 A1
(43) Pub. Date: Oct. 20, 2005

(54) Method and apparatus for push-to-talk communications

(76) Inventors: Geng Wu, Plano, TX (US); Xiao-Dong Li, Nepean (CA); James Weisert, Calgany (CA)

Correspondence Address: DUKE W. YEE, YEE & ASSOCIATES, P.C., P.O. BOX 802333, DALLAS, TX, 75380, US

(21) Appl. No.: 11/093,778

(22) Filed: Mar. 30, 2005

Related U.S. Application Data
(60) Provisional application No. 60/558,082, filed on Mar. 31, 2004.

(51) Int. Cl. H04L 12/66

(52) U.S. Cl. 370/352

(57) ABSTRACT

A method, apparatus, and computer instructions for managing push-to-talk communications. Different types of PTT calls with a variety of protocol configurations are supported with the use of PTT Type and Protocol Type fields in a call set up control message. When a push-to-media indicator in a call set up request message is detected in a radio access network in a communications system, the packet is directed to a push-to-media gateway in a packet data network in the communications system. The push-to-media packet is processed using the push-to-media gateway to manage the push-to-media call. This directing of the packet reduces the latency in managing a push-to-media call.

### RELATED PROVISIONAL APPLICATION

The present invention is related to and claims the benefit of priority of provisional U.S. Patent Application Ser. No. 60/558,082 entitled “CDMA Push-To-Talk Solution,” filed on Mar. 31, 2004, which is hereby incorporated by reference.

### FIELD OF THE INVENTION

The present invention relates generally to an improved communications system and in particular, to a method and apparatus for setting up and managing push-to-talk communications.

### BACKGROUND OF THE INVENTION

Mobile communication devices, such as mobile telephones have emerged as a commonly used device in business and in personal use. Networks for providing mobile communications include both circuit switched voice communication systems and packet switched data communication systems. The wireless networks were originally designed to service circuit switched voice communications. Recently, many mobile service providers have upgraded wireless networks to support packet switched data communication services. These services are intended to extend the common data communication capabilities of the wire domain to the wireless mobile domain. In providing this type of access, a radio access network (RAN) is used to provide interface between the transmission of the packet data over the air interface of the radio network and the transmission of the packet data to a fixed network.

In a packet-switched network, each packet is routed individually through the network. Packets for a particular call may take a number of different paths to the destination. This type of routing is in contrast to the traditional circuit switched approach to telephone service in which a path is provided through the network for the duration of the call. Packet switching uses a standard packet protocol, such as the Internet Protocol (IP). The routing decision regarding each packet's next hop through the packet-switched network is made on a hop-by-hop basis. A circuit-switched link provides a constant sequential throughput with minimal delay caused by the network. In contrast, because packets in a packet-switched network may take different paths, the arrival time may vary and the packet may arrive out of sequence. The process and procedures used to conceal the jitter and to place the packet in the correct sequence may result in a delay. Other factors associated with the transfer of packets also may provide for other delays. For example, some paths may require more time to transfer packets than others, and the link throughput may change in time due to network loading.

Wireless data services may support a range of different communication features using two-way packet switched packetized data, such as browsing websites, instant messaging, and e-mail. Wireless operations for data calls are tailored to support traditional IP packet based service applications.

As the speed of packet-switched communications equipment and the speed of processors have increased, applications for using IP packet transport as a medium for voice communications have arisen. Such applications are often referred to as voice over IP or “VoIP” services. One particular type of service provided through voice over IP is push-to-talk (PTT). With PTT communications, several mobile stations are used, which are all connected to the wireless network. Any user who wishes to speak pushes a button on their mobile station causing the mobile station to transmit. Releasing the button causes the mobile station to receive. A large number of users may share the same frequency. A voice over IP implementation of a PTT service application uses separate packet links for user mobile stations. Additionally, a dispatch process is provided on a server to handle the packets. The sender mobile station uses its up link through the wireless packet data service to upload the sender's audio information to a PTT server. Other member or members of the PTT group obtains the data from the server via their packet service link. Each of the receiving mobile stations converts the data back to digitized voice. To further improve radio resource efficiency, users participating in the same conversation may share one packet service link by tuning to the same channel if they are within the same cell coverage area.

Voice over IP service applications, such as PTT, however, present a different set of demands on a radio access network as compared to traditional packet data service applications. Like normal voice telephone services, most voice over IP services are more sensitive to latency and delay issues than regular data applications using a packet protocol. In addition, a user expects to listen or to speak in real time with PTT services at the press of a button.

The need to overcome latency (delay in connection time), which is a typical problem when handling voice calls on a data network, still remains an issue with regard to push-to-talk technologies. PTT latency includes the delay that is realized from the time an originator presses the PTT button on a mobile station to initiate voice communication with one or a group of targets and the time the originator receives an indication that the group communication server has granted the originator permission to send media. End-to-end voice latency is the delay that is realized between the time the originator begins to speak and the time the target or targets hears the originator's voice. Delays disrupt and cause frustration in voice over IP services. The differences in delay between packets, if large, may produce an audible jitter.

Different problems, such as delays in setting up calls and delays in transmitting packets through a network are examples of factors that cause interruptions or delays in real time conversations that are unacceptable or frustrating to users of these services. Therefore, it would be advantageous to have improved method, apparatus, and computer instructions for setting up and managing voice data transmitted over a packet network.

### SUMMARY OF THE INVENTION

The present invention provides a method, apparatus, and computer instructions for managing push-to-talk communications. When a push-to-media indicator in a packet is detected in a radio access network in a communications system, the packet is directed to a push-to-media gateway in a packet data network in the communications system. The push-to-media packet is processed using the push-to-media gateway to manage the push-to-media call. This directing of the packet reduces the latency in managing a push-to-media call.

Other aspects and features of the present invention will become apparent to those ordinarily skilled in the art upon review of the following description of specific embodiments of the invention in conjunction with the accompanying figures.

### BRIEF DESCRIPTION OF THE DRAWINGS

The novel features believed characteristic of the invention are set forth in the appended claims. The invention itself, however, as well as a preferred mode of use, further objectives and advantages thereof, will best be understood by reference to the following detailed description of an illustrative embodiment when read in conjunction with the accompanying drawings, wherein:

FIG. 1 is a communication system depicted in accordance with an illustrative embodiment of the present invention;

FIG. 2 is a diagram illustrating a data processing system that may be used to implement a gateway or server depicted in accordance with an illustrative embodiment of the present invention;

FIG. 3 is a diagram illustrating data flow in an air interface and network interface during PTT set up depicted in accordance with an illustrative embodiment of the present invention;

FIG. 4 is a diagram of components used during a push-to-talk call depicted in accordance with an illustrative embodiment of the present invention;

FIG. 5 is a diagram illustrating a data burst message depicted in accordance with an illustrative embodiment of the present invention;

FIG. 6 is a table illustrating PTT types depicted in accordance with an illustrative embodiment of the present invention;

FIG. 7 is a table illustrating protocol types depicted in accordance with an illustrative embodiment of the present invention;

FIGS. 8A-8C are diagrams illustrating different states in a “Simple PTT” push-to-talk system depicted in accordance with an illustrative embodiment of the present invention;

FIGS. 9A-9C are diagrams illustrating an “Always-On” type of PTT solution depicted in accordance with an illustrative embodiment of the present invention;

FIG. 10 is a signaling diagram illustrating an Always-On PTT call flow depicted in accordance with an illustrative embodiment of the present invention;

FIG. 11 is a flowchart of a process for handling a data burst message depicted in accordance with an illustrative embodiment of the present invention; and

FIG. 12 is a diagram illustrating a broadcast multicast service depicted in accordance with the preferred embodiment of the present invention.

### DETAILED DESCRIPTION OF THE PREFERRED EMBODIMENT

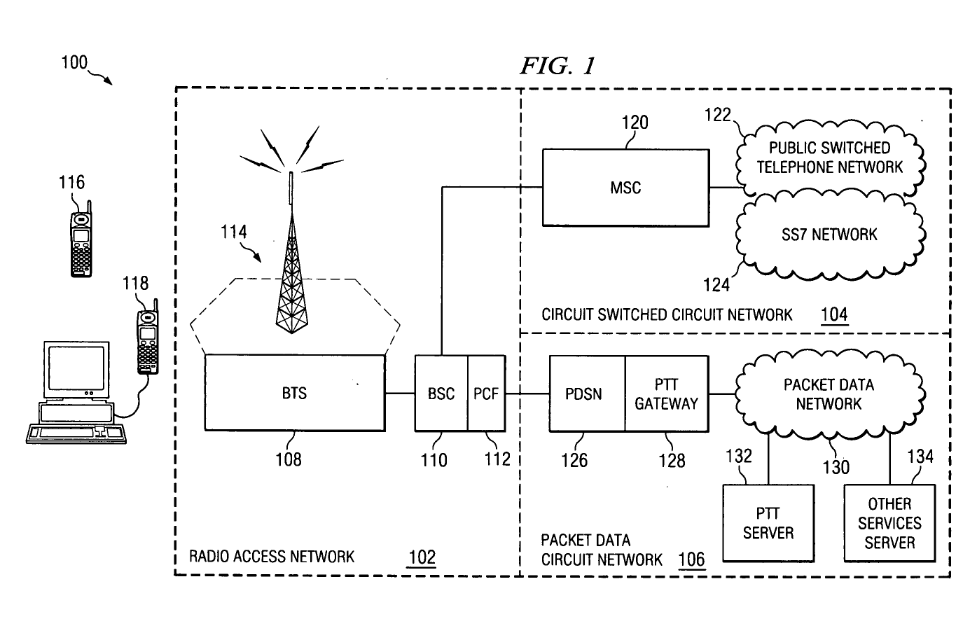

With reference now to the figures and in particular with reference to FIG. 1, a communication system is depicted in accordance with an illustrative embodiment of the present invention. Communication system 100 includes a number of different networks. In this illustrative example, communication system 100 includes radio access network (RAN) 102, circuit switched circuit network (CN) 104, and packet data circuit network 106. AS illustrated, RAN 102 includes base transceiver station (BTS) 108, base station controller (BSC) 110, and packet control function (PCF) 112. BTS 108 is coupled to antennae 114 and provides a coverage area also referred to as a “cell”. BTS 108 is used to send and receive radio frequency (RF) signals to and from mobile stations, such as mobile stations 116 and 118. BTS 108 is connected to BSC 110, which controls the function for a number of BTSs, such as BTS 108. BSC 110 helps manage how calls made by each mobile station are transferred or “handed-off” from one base station to another. The equipment implemented within BSC 110 and BTS 108 may vary depending on the particular vendor. PCF 112 provides a packet control function for handling packets that may be transferred to and from BSC 110. In many cases, BSC 110 and PCF 112 may be implemented as a single component.

Circuit switched circuit network 104 contains mobile switching center (MSC) 120, public switched telephone network (PSTN) 122, and SS7 network 124. Mobile switching center 120 provides for the receiving and sending of calls from BSC 110 and within PSTN 122. SS7 network 124 provides signaling to set up and manage these calls. Public switched telephone network 122 is the network to which landline phones are connected.

Packet data circuit network 106 contains packet data service node (PDSN) 126, push-to-talk (PTT) gateway 128, packet data network (PDN) 130, PTT server 132, and other services server 134. PDSN 126 is connected to BSC 110 and PCF 112 within radio access network 102. PDSN 126 and PTT gateway 128 are both connected to PDN 130. PTT server 132 and other services server 134 are also connected to PDN 130. These different servers provide services to mobile stations, such as mobile stations 116 and 118.

In these examples, communication system 100 contains a CDMA 2000 communications system. CDMA 2000 is a registered trademark of the telecommunications industry association (TIA-USA). This type of system is a third generation (3G) mobile telephone technology based on IS-95 by TIA/Electronics Association (TIA/EIA). In this type of system, 3G provides an ability to transfer both voice data and non-voice data.

In addition, although the depicted examples are presented with reference to a specific type of communication system, the mechanism of the present invention may be applied to any type of communication system in which PTT communications are provided. Further, although these examples are mainly directed towards PTT communications using voice, the present invention may be applied to any type of push-to-media services, such as, for example, video or pictures. The illustration of these components in FIG. 1 are not meant to imply architectural imitations to the manner in which the illustrative embodiments may be implemented.

In an illustrative embodiment, PTT server 132 provides the functionality for PTT communications between different mobile stations. Additionally, PTT gateway 128 is included in this illustrative embodiment of the present invention to reduce the delay and latency in setting up and transferring data for voice communications being transferred through packets within communication system 100. PTT gateway 128 also is referred to as a push-to-media gateway because this gateway also is used to process other types of media other than voice in the illustrative embodiments.

In accordance with a preferred embodiment of the present invention, PTT gateway 128 is used to remove and put back header information within data packets being transferred to and from PDSN 126. With the use of PTT gateway 128 in conjunction with PTT server 132, the present invention provides a mechanism for improved PTT performance in which fast call set up, low latency, full-range vocoder operation, and high system capacity are provided. This mechanism is designed in these illustrative examples to be compatible with 3G architecture as well as being able to support other types of push-to-media services other than PTT. PTT gateway 128 allows for PTT data to be directed towards this component for faster processing as opposed to being routed and processed using currently available routing and processing mechanisms.

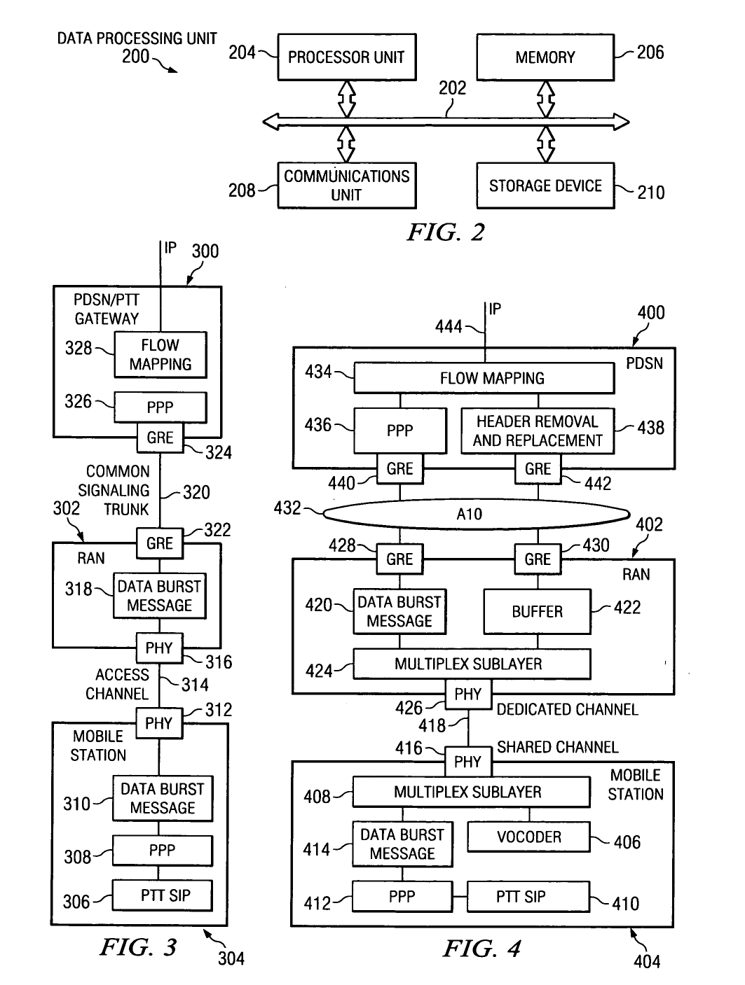

Turning next to FIG. 2, a diagram illustrating a data processing system that may be used to implement a gateway or server is depicted in accordance with an illustrative embodiment of the present invention. Data processing system 200 includes bus 202, which provides an interconnection between processor unit 204, memory 206, communications unit 208, and storage device 210. Although this illustrative example interconnects the different components using a bus, any sort of interconnect architecture or fabric may be used in data processing system 200.

Processor unit 204 contains one or more processors to execute instructions that may be stored in memory 206. These instructions are executed to provide the functions and processes described for the illustrative embodiments of the present invention. Communications unit 208 provides an interface to send and receive data and/or commands. Storage device 210 provides a medium in which data and programs for the processes and functions in the illustrative embodiment of the present invention may be stored. Processor unit 204 may contain a single processor or may contain multiple processors, such as those in a symmetric multiprocessing system.

Further, memory 206 also includes an operating system used to facilitate the execution of programs or software implementing the functions and processes in the illustrative embodiments. This operating system may be, for example, a LINUX operating system or a windows based operating system. Windows based operating systems, such as Windows 2003 are available from Microsoft Corporation. Additionally, an object-oriented programming system, such as Java, may run in conjunction with the operating system and provide calls to the operating system from Java programs or applications executing on data processing system 200. Instructions for the operating system, object-oriented programming system, and applications or programs are located on storage device 210. These instructions are loaded into memory 206 for execution by processor unit 204.

The depicted example in FIG. 2 and the other described examples are not meant to imply architectural imitations to the manner in which the illustrative embodiments may be implemented. For example, data processing system 200 also may be implemented for use in a BSC, such as BSC 110 in FIG. 1.

The present invention provides a method, apparatus, and computer instructions for managing push-to-media calls in a communication system. Specifically, the mechanism of the present invention reduces the delays in setting up and transferring packets for a push-to-media call. The examples illustrated below are described specifically with the media being voice for a PTT call. The mechanism of the present invention involves providing processing for PTT data, such as removing header information from voice packets in the PDSN using a component dedicated to process PTT data. Specifically, the mechanism of the present invention provides a PTT gateway, such as PTT gateway 128 in FIG. 1 to add and remove IP protocol headers in the voice packets. By reducing the size of the voice over IP packets, the packets may be more efficiently transferred over the air. The header information may be placed back into the packets when the packets reach a PDSN for forwarding to the PTT server in the packet network. Additionally, the mechanism of the present invention also includes providing a persistent IP address for a mobile station that is in a dormant or stand-by state. With a persistent IP address, the mobile station is logically in an “Always-On” mode for IP based data services, since the network is always able to reach the mobile station by directing traffic to the mobile station's IP address. In this manner, a mobile station that is the recipient or end point for a PTT call may be found more quickly.

With reference next to FIG. 3, a diagram illustrating data flow in an air interface and network interface during PTT set up is depicted in accordance with an illustrative embodiment of the present invention. In this example, the components involved in setting up a PTT call include PDSN/PTT gateway 300, RAN 302, and MS 304. In this example, mobile station 304 includes PTT-related modules such as PTT session initiation protocol (SIP) 306, point-to-point protocol (PPP) 308, and data burst message 310.

These components are used to generate messaging needed to set up a PTT call. For PTT call origination, the messaging is sent through physical interface 312 across access channel 314. PTT SIP 306 is a session initiation protocol software unit or component used to provide packet processing function for SIP packets. PTT SIP 306 is a component that implements SIP in an application layer control protocol for creating, modifying, and terminating sessions with one or more participants. In these examples, the session is for a PTT call. This component also provides a registration function that allows users to indicate implicitly current locations for use by the communication system. More information on SIP may be found in SIP: Session Initiation Protocol, Rosenberg, et al., RFC 2543, March 1999 and in SIP: Session Initiation Protocol, Rosenberg, et al., RFC 3261, June 2002.

PPP 308 is a software unit or component used to transmit network data generated by PTT SIP 306 as well as set data to PTT SIP 306. PPP 308 implements the protocol PPP, which is used to transmit messages over serial point-to-point links in a network. This protocol allows mobile station 304 to connect itself to the Internet rather than logging on through a service provider system. Note that the use of PPP in this invention serves only as an example. Protocols that provide similar function may also be used in place of PPP.

In these illustrative examples, data burst message 310 is used to generate messages in a format for transmission to a BTS. Data burst messages are the common format for messages sent over common or dedicated traffic channels. Data burst message 310 generates a message to indicate that the call is a PTT call in these examples. This message may include a group ID or destination address as well as a PTT burst type. This type of message is used by many services in addition to those for PTT.

A message generated by data burst message 310 is sent across access channel 314 and received at physical interface 316 within RAN 302. This component processes the message at data burst message 318. In these examples, data burst message 318 is located in a BSC, such as BSC 110 in FIG. 1. This component recognizes that the message is a PTT message and directs the message to a PTT gateway, which is in these examples implemented within PDSN/PTT gateway 300. In directing the message, the information is changed into a format for transmission across common signaling trunk 320 using GRE interface 322. This message is received at GRE interface 324 within PDSN/PTT gateway 300.

Specifically, the message is received by PPP 326. PPP 326 is implemented at a gateway, such as PTT gateway 128 in FIG. 1. A BSC in RAN 302 directs the message to the gateway in these illustrative examples, rather than using normal routing of packets. This information is then forwarded to the PTT server within the packet data core network as its final destination. Flow mapping 328 sends packets to the destination.

With reference now to FIG. 4, a diagram of components used during a push-to-talk call is depicted in accordance with an illustrative embodiment of the present invention. In this example, the components include PDSN 400, RAN 402, and mobile station 404. In this example, the components and mobile station involved in a PTT call include vocoder 406, multiplex sublayer 408, PTT SIP 410, PPP 412, data burst message 414, and physical interface 416. Vocoder 406 provides for the coding and decoding of voice found in data packets. When a user of mobile station 404 talks, vocoder 406 encodes the voice into packets. When voice data is received in the packets, vocoder 406 decodes those packets back into voice to be presented to the user of mobile station 404.

PTT SIP 410, PPP 412, and data burst message 414 are components within mobile station 404 that are employed to generate signals and manage the PTT call. For the direction from the RAN 402 to the mobile station 404, data burst messages are received by data burst message 414 from multiplex sublayer 408. Packets containing voice also are sent to vocoder 406 by multiplex sublayer 408. This particular component is employed to send the appropriate packets to the appropriate components within mobile station 404.

Additionally, for the direction from the mobile station 404 to the PAN 402, multiplex sublayer 408 receives packets from data burst message 414 and vocoder 406 and sends them on to channel 418 using physical interface 416. Channel 418 may be a dedicated or shared channel depending on the particular implementation. The traffic channel assigned for the voice communications is automatically routed to the PTT gateway. In these examples, the voice packets are directed to the gateway without requiring indicators to be placed in the packets. The traffic channel and the mobile station are associated with the PTT call. The association between the mobile station using this traffic channel and the PTT gateway for routing these voice packets within the RAN to the PTT gateway has been determined when the PTT call was set up. As a result, voice packets associated with the mobile station over the traffic channel are routed to the PTT gateway without requiring additional indicators.

RAN 402 contains data burst message 420, an optional buffer 422 to compensate for transport delay variation, multiplex sublayer 424, physical interface 426, GRE interface 428 for signaling messages, and GRE interface 430 for voice packets. Physical interface 426 receives data burst messages and voice packets from channel 418. These data burst message packets are identified as being PTT messages using indicators in the messages and packets in these illustrative examples.

Multiplex sublayer 424 receives these packets and distributes them to the appropriate components. Data burst messages are sent to data burst message 420 for processing while voice packets are sent to buffer 422. GRE 428 and GRE 430 send the different packets to PDSN 400 across the A10 Interface 432. In this example, A10 interface 432 has two flows. One flow is for the data burst messages for PTT call control while the other flow is for voice data.

PDSN 400, in this example, contains flow mapping 434 for the PTT server to the mobile station direction, PPP 436, header removal 438 for the PTT server to the mobile station direction, and header replacement 438 for the mobile station to the PTT server direction, GRE interface 440, and GRE interface 442. GRE interface 440 receives data burst messages from RAN 402, while GRE interface 442 receives voice packets from RAN 402. PPP 436 is used to carry data through IP connection 444.

Header removal 438 is employed to remove header information from the headers of voice packets before sending over the air. In these illustrative examples, this particular component has been added to PDSN 400 to reduce the delay in voice data. This header removal is similar to an existing standard service option, such as SO60. Service option is a standard method to identify the specific requirements or radio configuration for supporting a specific service. For example, a service option may identify coders, channel configurations, and data rates. SO60 is a standardized service option, which indicates headers should be removed from data packets. This service option is used to allow the network to identify or know what is needed to service a particular call.

By removing header information from voice packets at this point of the PTT call, the mechanism of the present invention reduces the amount of data that is to be transmitted over the air. This function significantly increases the system capacity. Additionally, when data is sent from mobile station 404, this component is used to add header information back into the voice packets. Flow mapping 434 is employed to map incoming IP packets from the packet network to PPP 436 and header removal 438.

As can be seen, two basic flows are present in the diagram illustrated in FIG. 4. One flow involves a signal path to provide for call control and other management of a PTT call. The other path for voice packets is a path used by the applications to send voice data back and forth in the PTT call. The voice packets sent across IP connection 444 are processed by PTT server and sent to other mobile stations in these illustrative examples. The mobile stations at the receiving end use a similar flow as illustrated in FIG. 4 with the voice packets flowing to the mobile station.

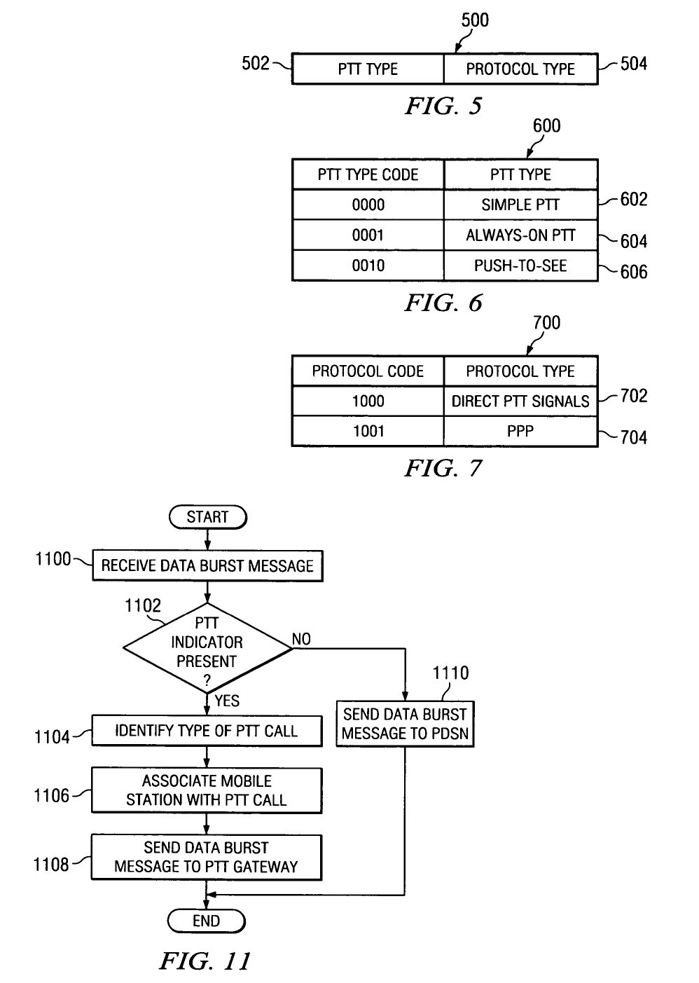

Turning now to FIG. 5, a diagram illustrating a data burst message is depicted in accordance with an illustrative embodiment of the present invention. Data burst message 500 is an example of a message that may be used to set up and manage PTT calls. In this example, data burst message 500 may be a message specially defined for PTT calls. Alternatively, data burst message 500 may be implemented reusing an existing short data burst type data message currently found in CDMA 2000 systems. In other words, a currently used type of data burst message may be used or a new type of data burst message may be defined to implement this PTT-specific data burst message 500. Data burst message 500 contains PTT type 502 and protocol type 504. PTT type 502 contains a parameter used to distinguish different push-to-media services. For example, the push-to-media may be voice, which is a typical PTT call. Additionally, other types of media, such as video or pictures may be defined for the push-to-talk mechanism in the illustrative examples. In an alternative implementation of this invention, GPM (General Paging Message, from network to mobile station)/ORM (Origination Massage, from mobile station to network) are used instead of DBM (Data Burst Message). In this alternative implementation, the PTT type is sent using a sync ID field, rather than in data burst message 500. This parameter in PTT Type code 502 is used by the RAN to direct the messages and packets to a PTT gateway in the illustrative embodiments.

In this manner, the data, such as data burst messages and voice packets, for a PTT call are processed more efficiently and with less delay as compared to the currently available systems for handling these types of calls.

Turning now to FIG. 6, a table illustrating PTT types is depicted in accordance with an illustrative embodiment of the present invention. Table 600 contains a PTT type code and a PTT type identification for the code for each entry. In this illustrative example, three entries are present in table 600. Entry 602 contains the code “0000”, which indicates a simple PTT. A code of “0001” indicates an always-on PTT type for the call in entry 604. In entry 606, the code “0010” indicates a push-to-see type of PTT call. The always-on PTT type is used when the mobile station implements PPP and has an IP address. As described above, PPP is a point-to-point protocol used to transmit network data. In actual implementation, alternative protocols of similar function may be used in lieu of PPP. Simple PTT is implemented when the mobile station does not support IP/PPP protocols. A PTT type of push-to-see indicates another type of push-to-media, such as video or pictures.

Turning now to FIG. 7, a table illustrating protocol types is depicted in accordance with an illustrative embodiment of the present invention. In table 700, each entry includes a protocol code and a protocol type. Entry 702 and 704 are present in these illustrative examples. A protocol code of “1000” indicates direct PTT signaling in entry 702, while a protocol code of “1001” indicates a PPP type of protocol in entry 704.

The different PTT types and protocol types illustrated in the tables in FIGS. 6 and 7 are for purposes of depicting one illustrative embodiment of the present invention. Of course, the mechanism of the present invention may be applied to other types of PTT services and protocol types. Further, other types of coding systems may be used in addition to those shown in FIGS. 6 and 7.

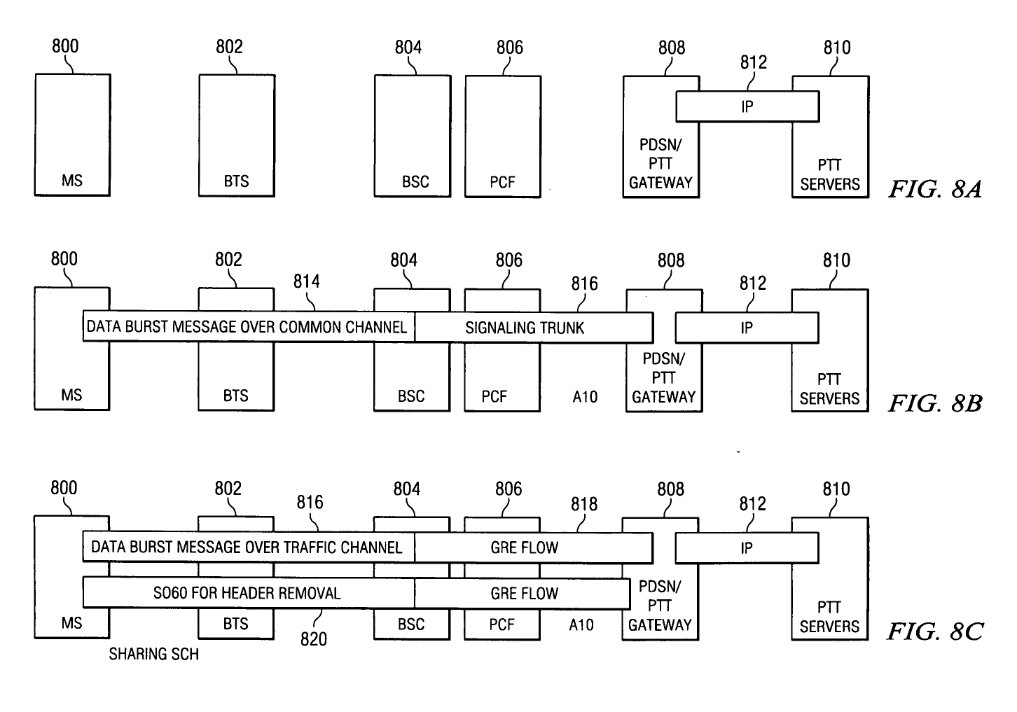

Turning now to FIGS. 8A-8C, diagrams illustrating different states in a “Simple PTT” push-to-talk system are depicted in accordance with an illustrative embodiment of the present invention. This Simple PTT type of calls is identified by setting the PTT Type Code to 0000, as described in FIG. 6. In FIG. 8A, the push-to-talk connection is idle in an idle state. In this example, mobile station (MS) 800, base transceiver station (BTS) 802, base station controller (BSC) 804, packet control function (PCF) 806, packet data service node (PDSN)/PTT gateway 808, and PTT servers 810 are illustrated. In this example, the mobile station does not employ IP protocol. IP connection 812 is present only between PDSN/PTT gateway 808 and PTT servers 810. In this idle state, there is no communication being sent or received with respect to this unit. No PTT connection is present in FIG. 8A. In FIG. 8A, mobile station 800 powers up and authenticates with the radio air network. No other actions occur in this presently used system. In FIG. 8B, a set up for a PTT connection is illustrated. A data burst message is sent over a common channel as shown in path 814. This path begins at mobile station 800, passes through BTS 802, and terminates at BSC 804. At BSC 804, the message is sent to PDSN/PTT gateway 808 through PCF 806 using signaling trunk 816. In this example, the data burst message is used to originate or set up a PTT connection. The data burst type is set as PTT in the data burst message. In an alternative implementation, Origination Message (ORM) can be used instead of data burst message.

In FIG. 8C, a traffic channel is assigned to mobile station following necessary signaling exchanges between mobile station and network. In this example, a PTT call in an active state is illustrated. In this example, signaling is carried over a common traffic channel as shown in path 816. In this example, this signaling is carried using a data burst message which is sent by mobile station 800 to BSC 804 through the assigned traffic channel for the PTT call. This message is then transferred from BSC 804 to PDSN/PTT gateway 808 through generic routing encapsulation flow path 818. This path flows from BSC 804 through PCF 806 to PDSN/PTT gateway 808. Generic routing encapsulation (GRE) is a tunneling protocol that may be used to encapsulate a wide variety of protocol packet types within an IP tunnel. From PDSN 808, signaling messages and voice data are sent to PTT servers 810 through IP connection 812.

In this example, the voice packet has no protocol header, which is similar to SO60 traffic over the air. For network to mobile station direction, the traffic channel may be a shared channel. A shared channel is used if multiple users are going to be on the same particular call within the same cell coverage area. Although this channel is a “shared channel”, it is dedicated to a particular group of users.

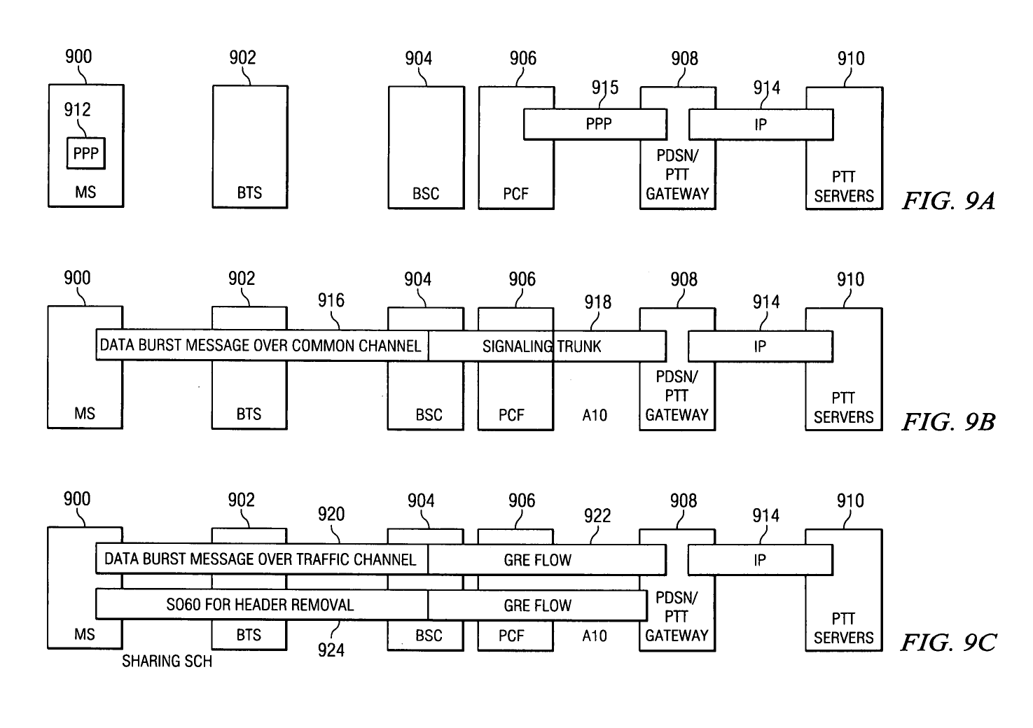

Turning now to FIGS. 9A-9C, diagrams illustrating an “Always-On” type of PTT solution is depicted in accordance with an illustrative embodiment of the present invention. In this example, mobile station 900, BTS 902, BSC 904, PCF 906, PDSN/PTT gateway 908, and PTT servers 910 are shown in a dormant or idle state in FIG. 9A. In contrast to the simple PTT shown in FIGS. 8A-8C, mobile station 900 implements point-to-point protocol 912. In other words, mobile station 900 has an assigned IP address allowing it to be located even though mobile station 900 is in a dormant or idle state. In this example, a logical IP connection 914 is present between mobile station 900 and PTT servers 910. Additionally, PPP connection 915 is present between mobile station 900 and PDSN/PTT gateway 908. PPP is an example implementation. Other protocols providing similar function may also be used.

In FIG. 9B, an illustration of signaling and connections between components is illustrated during a set up phase for a PTT call. A data burst message is sent from mobile station 900 to PTT servers 910. This data burst message first travels across a common channel, such as the Access Channel or the enhanced access channel as examples, through path 916 through BTS 902 to BSC 904. From BSC 904, this message is sent to PDSN/PTT gateway 908 through signaling trunk 918. Thereafter, the message is conveyed from PDSN/PTT gateway 908 to PTT servers 910 through IP connection 914.

In FIG. 9C, the PTT call is in an active state. In this illustrative example, for control signaling, mobile station 900 sends data burst messages to PTT servers 910 through a traffic channel across path 920. In this example, the traffic channel is now an assigned traffic channel for the particular PTT call. Thereafter, the data burst message travels from BSC 904 to PDSN/PTT gateway 908 through GRE flow 922. Thereafter, the data burst message is transmitted to PTT servers 910 across IP connection 914. Voice data is sent from mobile station 900 to PDSN/PTT gateway 908 through GRE flow 924. Thereafter, the voice data is sent to PTT servers 910 through IP connection 914.

A similar set of states and flow of messages occur for a push-to-media call using media other than voice. For example, the states illustrated in FIGS. 9A-9C may be implemented for a push-to-media call involving video or pictures.

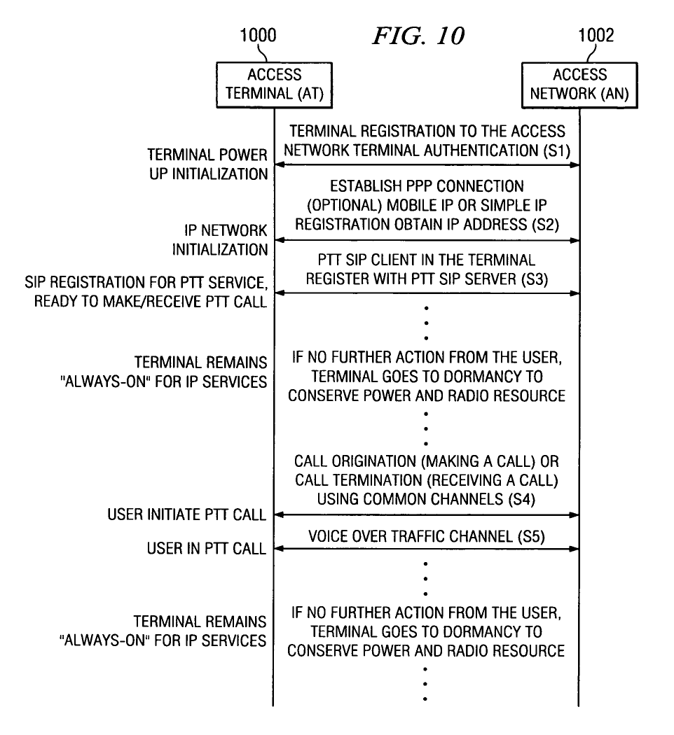

With reference next to FIG. 10, a signaling diagram illustrating an Always-On PTT call flow is depicted in accordance with an illustrative embodiment of the present invention. In this example, access terminal 1000 and access network 1002 are the components involved in the PTT call flow. The process begins with access terminal 1000 powering up and performing terminal registration to access network 1002 and terminal authentication (step S1). Next, the IP network initialization occurs at access terminal 1000. In this initialization, an optional PPP connection is established, mobile IP registration occurs, and an IP address is obtained by access terminal 1000 from access network 1002 (step S2).

Next, access terminal 1000 performs SIP registration to PTT server for PTT service and then moves into a ready to make or receive PTT call mode. In performing this, a PTT SIP client in access terminal 1000 registers with a PTT SIP server located within network (step S3). Thereafter, access terminal 1000 remains always on for IP services in these illustrative examples. If no further action occurs from the user, access terminal 1000 moves into a dormancy or dormant state to conserve power and radio resources. Next, a user initiated PTT call occurs with respect to access terminal 1000, which may be a call origination or a call termination using common channels (step S4). Thereafter, a user PTT call is in progress at access terminal 1000 resulting in voice packets over the traffic channel being exchanged between access terminal 1000 and access network 1002 (step S5). If no further action occurs from the user, the terminal remains always on for IP services and moves into a dormancy or dormant state to conserve power and radio resources.

The different messages in the voice traffic illustrated in FIG. 10 are directed by the access network to a PTT gateway, such as PTT gateway 128 in FIG. 1, which then pass it on to PTT server. The specific routing configuration is determined by the access network according to the PTT type indicators such as those illustrated in FIG. 6. In these illustrative examples, a component in the radio access network portion of the access network, such as a BSC, directs these packets to the PTT gateway. In contrast, currently available systems simply place the packets into a packet data network, rather than routing them to a specific gateway for PTT calls. With this routing, the mechanism of the present invention reduces the latency needed to process packets for PTT calls.

With reference now to FIG. 11, a flowchart of a process for handling a data burst message is depicted in accordance with an illustrative embodiment of the present invention. The process illustrated in FIG. 11 is implemented within a radio access network.

The process begins by receiving a data burst message (step 1100). A determination is made as to whether the data burst message contains a PTT indicator. This indicator may take various forms depending on the particular implementation. In these examples, the indicator is a four-bit indicator, such as those shown in FIG. 6.

If the indicator is a PTT indicator, the type of PTT call is identified from the indicator (step 1104). The mobile station is associated with the PTT call (step 1106). Thereafter, the data burst message is sent to the PTT gateway (step 1108) with the process terminating thereafter.

With reference next to step 1102, if a PTT indicator is absent, the data burst message is treated as normal packet data service and sent to PDSN for processing (step 1110) with the process terminating thereafter. In these examples, the access network associates the mobile station with the PTT call, such that when a traffic channel is later assigned for voice data, all data from this mobile station over the particular traffic channel are directed to the PTT gateway rather than generally to the PDSN. In this manner, the mechanism of the present invention reduces the latency of PTT calls through reducing the time needed to process packets for PTT calls in a PDSN.

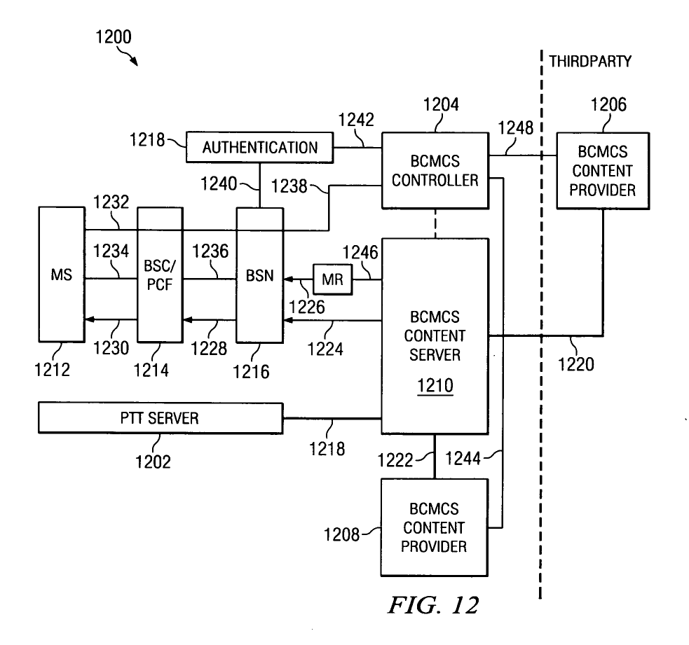

Turning next to FIG. 12, a diagram illustrating a broadcast multicast service is depicted in accordance with the preferred embodiment of the present invention. In many cases, more users may be present than a particular cell can support for PTT calls. The present invention recognizes that in many cases, such as those involving emergency services, many of the mobile station users do not need to talk, but only need to hear or receive information from a small number of users to receive directions. The mechanism of the present invention provides a broadcast multicast service to facilitate this system. In this example, broadcast system 1200 includes PTT server 1202. This particular component is responsible for emergency service and serves as a broadcast multicast service content provider. BCMCS controller 1204 is used by an operator or other user to set up the service. The content may be received by PTT server 1202 or from another third party, such as BCMCS content provider 1206. A multicast router (MR) may be used in the system to support multicast protocol. In this example, BCMCS content provider 1208 also may provide content for broadcast to other users. BCMCS content server 1210 is employed to receive the content for PTT server 1202, BCMCS content provider 1206, and BCMCS content provider 1208. In this illustrative example, mobile station 1212 may receive PTT broadcasts sent through BSC/PCF 1214 and BSN 1216. BSN 1216 is similar to a PDSN and can actually be a component located in a PDSN in these examples. Authorization, authentication, and accounting (AAA) server 1218 is used to authenticate mobile stations. This server is employed to control access to network resources, enforce policies, audit usage and provide information needed to bill for services accessed by mobile stations. In these illustrative examples, a mobile station receives these broadcasts only if the mobile station is authenticated and authorized. Authentication may be optional depending on the particular implementation. In many cases, broadcasts may be designated for selected users. In this example, paths 1218, 1220, and 1222 are paths for original content. Paths 1224, 1228, and 1230 indicate the path for content that may be modified by BCMCS content server 1210 prior to being received by mobile station 1212. Path 1232, 1234, 1236, 1238, 1240, 1242, 1244, 1246, and 1248 are signaling paths used to manage the PTT broadcasts. MR 1226 implements read-solomon code for coverage in this example.

Silent users may be required to be authorized through authentication 1218 by the system to decode encrypted information. The content provided through this system may be distributed to an extremely large geographic area; such as a city or a state.

It is important to note that while the present invention has been described in the context of a fully functioning data processing system, those of ordinary skill in the art will appreciate that the processes of the present invention are capable of being distributed in the form of a computer readable medium of instructions and a variety of forms and that the present invention applies equally regardless of the particular type of signal bearing media actually used to carry out the distribution. Examples of computer readable media include recordable-type media, such as a floppy disk, a hard disk drive, a RAM, CD-ROMs, DVD-ROMs, and transmission-type media, such as digital and analog communications links, wired or wireless communications links using transmission forms, such as, for example, radio frequency and light wave transmissions. The computer readable media may take the form of coded formats that are decoded for actual use in a particular data processing system. The description of the present invention has been presented for purposes of illustration and description, and is not intended to be exhaustive or limited to the invention in the form disclosed. Many modifications and variations will be apparent to those of ordinary skill in the art. For example, although the depicted embodiments are directed towards a single type of media in a PTT call, the mechanism of the present invention may be applied to handle multiple types of media. For example, a PTT call may include voice and video data packets. The embodiment was chosen and described in order to best explain the principles of the invention, the practical application, and to enable others of ordinary skill in the art to understand the invention for various embodiments with various modifications as are suited to the particular use contemplated.

1. A method in a communications system for managing a push-to-media call, the method comprising:
responsive to detecting a push-to-media indicator in a packet in a radio access network in the communications system, directing the packet to a push-to-media gateway in a packet data circuit network in the communications system; and
processing the push-to-media packet using the push-to-media gateway to manage the push-to-media call.

2. The method of claim 1, wherein the directing step is performed by a base station controller.

3. The method of claim 1, wherein the gateway is located in a packet data service node.

4. The method of claim 1, wherein processing step includes:
removing header information from the packet.

5. The method of claim 1, wherein the packet is a data burst message for the push-to-media call.

6. The method of claim 1, wherein the packet is a voice packet for the push-to-media call.

7. The method of claim 1, wherein the push-to-media packet is for voice or video.

8. The method of claim 1, wherein the indicator is located in sync ID field in the push-to-media packet.

9. The method of claim 1, wherein the packet is a control message including a PTT type field and protocol type field used to specify a type of push-to-media call and a protocol for the push-to-media call.

10. A communications system comprising:
a radio access network, wherein the radio access network receives packets from a mobile station, directs a selected packet to a selected gateway in response to identifying the packet as belonging to a push to media call for the mobile station; and
a push-to-media gateway in a packet data service node, wherein the push to media gateway is the selected gateway and wherein the push to media gateway processes the selected packet such that latency in handling the push-to-media call is reduced.

11. The communications system of claim 10, wherein a base station controller in the radio access network receives the packets.

12. The communications system of claim 10, wherein the push-to-media-call is for at least one of voice data and video data.

13. The communications system of claim 10, wherein the selected packet is a data burst message containing an indicator used by the radio access network to identify the selected packet.

14. A computer program product in a communications system for managing a push-to-media call, the computer program product comprising:
first instructions, responsive to detecting a push-to-media indicator in a packet in a radio access network in the communications system, directing the packet to a push-to-media gateway in a packet data circuit network in the communications system; and
second instructions, processing the push-to-media packet using the push-to-media gateway to manage the push-to-media call.

15. The computer program product of claim 14, wherein the first instructions are executed by a access network.

16. The computer program product of claim 14, wherein the gateway is located in a packet data service node.

17. The computer program product of claim 14, wherein the second instructions includes:
sub-instructions for removing header information from the packet.

18. The computer program product of claim 14, wherein the packet is a data burst message for the push-to-media call.

19. The computer program product of claim 14, wherein the packet is a voice packet for the push-to-media call.

20. The computer program product of claim 14, wherein the push-to-media packet is for voice or video.
